(19) United States
(12) Patent Application Publication
(10) Pub. No.: US 2004/0103975 A1
(43) Pub. Date: Jun. 3, 2004

(54) Non-woven fabric

(76) Inventor: Alan John Brasier, Gloucestershire (GB)

Correspondence Address: RATNERPRESTIA, P O BOX 980, VALLEY FORGE, PA, 19482-0980, US

(21) Appl. No.: 10/618,161

(22) Filed: Jul. 11, 2003

Related U.S. Application Data
(62) Division of application No. 09/397,618, filed on Sep. 16, 1999.

(30) Foreign Application Priority Data
Sep. 17, 1998 (GB) 9820165.0

(51) Int. Cl. B32B 31/00

(52) U.S. Cl. 156/148; 156/186

(57) ABSTRACT

A ball-covering needlefelt produced by needling a fibre batt in a range of angles including a plurality of angles which are non-perpendicular to the plane of the batt. The range of angles is preferably achieved by the batt being curved during needling, the batt conveniently being curved in its direction of travel through the needling machine. The needleboard of the needling machine is preferably correspondingly curved.

The needling process produces a needlefelt having a high degree of fibre entanglement (comparable to woven ball-covering felts) and enables achievement of characteristics necessary for good wear and abrasion resistance without the excessive consolidation in conventional ball-covering needlefelts that leads to loss of flexibility (tending to faulty ball covering) and poor dynamic characteristics (making such balls unsuitable for professional use).

The invention is particularly applicable to the manufacture of championship-quality tennis balls.

This invention relates to a non-woven fabric and its uses, and relates more particularly but not exclusively to the use of a needlefelt for the covering of tennis balls, and to tennis balls so covered.

For the meaning of textile-related terms as used in this specification, attention is directed to the definitions in the reference book “Textile Terms And Definitions” (Eighth Edition) published in 1986 by The Textile Institute (of the United Kingdom). References in this specification to “tennis ball(s)” are to be taken as comprising references to analogous balls, i.e. to balls for games other than tennis but which are resilient hollow balls or otherwise structurally and functionally analogous to tennis balls, whether or not such analogous balls are interchangeable with tennis balls, and to felt-covered balls in general.

Traditionally, tennis balls have been covered with a felted textile material having a surface predominantly composed of wool fibres and based on a woven scrim or substrate. During the process of finishing the felted textile material, the scale structure of the wool fibres is utilised to produce the characteristic felted surface appearance of the ball.

Nowadays woven felts for covering tennis balls are produced with a surface that is commonly composed of a mixture of wool and polyamide fibres. Usually these fibres are mixed at a ratio of about 60% wool & 40% nylon, but this ratio may vary in dependence on the wear characteristic required of the ball. It is also desirable that the back side of the felt (which is the side of the felt intended to be adhered to the core of the ball) be made of a material which provides a good adhesion when it is glued onto the hollow rubber sphere forming the core of the ball. Usually such backing is made of cotton.

Following the introduction of needlefelting machines, attempts have been made to produce and utilise needlefelts (felts composed of non-woven fabrics and produced by needlefelting machines) for covering tennis balls. Needlefelting techniques can be used to produce a non-woven fabric for covering tennis balls in accordance with the following method: an appropriate blend of fibres, either dyed or undyed, is carded and cross-lapped to form a substantially horizontal fibre batt (a non-woven web). The fibres of the batt are provided in a generally planar configuration and are superimposed according to successive horizontal patterns. This batt is then passed through a known form of needlefelting machine. Such a needlefelting machine has at least one reciprocable panel (or “needleboard”) comprising a cluster or array of barbed needles arranged mutually parallel, pointing in the same direction, and secured on a common substrate or mounting. The needlefelting machine may have two independently operable needleboards arranged on mutually opposite sides of the fibre web and disposed in succession along the normally horizontal path followed by the batt as it passes through the machine during needlefelting operation. As the batt is passed horizontally through the needlefelting machine, the or each needleboard is vertically reciprocated to cause its cluster of barbed needles repeatedly to punch into and through the web, and then back out of the fabric web (on the same side as entry). The vertical passage of the barbed needles back and forth through the batt provokes a vertical entanglement of the fibres in the batt as the barbs of the needles carry some portion of the fibres along their pathways through the batt.

Needlefelting machines have a higher productivity of fabric than looms producing woven fabric, and needlefelting machines will produce a felted fabric without the need to incorporate costly wool fibres and without the need to apply expensive finishing processes to the fabric. Consequently ball-covering needlefelts are cheaper than ball-covering woven fabrics. However, needlefelts lack the flexibility that is characteristic of woven fabrics, and consequently when balls are covered with shaped blanks of needlefelt, the seams of the covering are liable to be defective due to puckering of the blanks. Also, the so-covered balls tend to feel hard when hit, exhibit poor flight characteristics, and have poor wear resistance. These adverse properties arise from the smoother surface and greater consolidation of non-woven felts in comparison to woven felts.

Attempts have been made to overcome the above-discussed defects of conventional needlefelted ball coverings, for example by modifying needling density (needle penetrations per unit area of web), or by incorporating a felt-backing scrim of greater flexibility; such attempts have not been successful. In a recent attempt to increase fibre entanglement in the finished felt, a percentage of wool fibre has been incorporated into the fibre blend prior to needlefelting, and the needlefelted fabric has been milled in a manner similar to the milling of woven felts. However, the non-woven fabrics that resulted from these procedures still failed to replicate the desirable characteristics of good-quality woven ball-covering felts.

A comparative study of the cross-sectional characteristics or microstructure of traditionally woven tennis ball felts and non-woven felts produced by needlefelting machines showed that fibres in woven felt are predominantly anchored in the base woven structure but are distributed in generally random directions throughout the surface pad of the felt, thus producing a high level of fibre intersections for a given density of felt. Also, the fibre density declines from the scrim (basecloth or backing) of the felt towards the opposite surface (normally the outer surface). The base structure retains a woven characteristic, and has a significantly greater fibre density than the outer surface. A typical woven ball-covering felt has a fibre density of 300 milligrams per millilitre at its base, diminishing to about 150 milligrams per millilitre towards the opposite (outer) surface. These characteristics, particularly the degree of fibre entanglement per unit density, are critical to the behaviour of the felt both during the ball-covering process and on the ball in play (i.e. in use). Conventional needlefelting techniques redistribute a proportion of the fibres laid predominantly horizontally during the cross-lapping process into a predominantly vertical configuration, the fibres needled to verticality intersecting those not impacted by the needles at or close to right angles. Also, the fibre density (excluding any scrim material) can be seen to be nearly consistent throughout the thickness of the felt. From these observations it becomes apparent that the ratio of fibre intersections or degree of fibre entanglement is much lower in needlefelt than in woven felt for a given density of material. Thus, in order to achieve acceptable abrasion resistance and wear resistance characteristics in a ball that is covered in a needlefelt by means of giving the needlefelt a level of fibre entanglement that is comparable to that in a woven ball-covering felt, it is necessary to apply a high needling density (number of needle penetrations per unit of web area). High needling density renders the resultant needlefelt significantly less flexible than woven ball-covering felt, thus making the ball-covering process more difficult and more prone to defects. Balls covered with highly needled felt feel harder when hit than balls covered in woven felt, and generally fly faster due to the needlefelt surface being smoother and more consolidated than the surface of a woven felt. Such deficiencies may not be particularly significant for recreational use of tennis balls, but the defects in ball characteristics renders such balls unacceptable for use in professional tennis and in championship-level tennis matches.

From the facts detailed above, it can be concluded that felted ball coverings produced using conventional nedlefelting techniques cannot replicate the density and wear characteristics equivalent to woven ball-covering felts and simultaneously provide the performance characteristics required of good-quality tennis balls (e.g tennis balls of championship standard).

It has now been discovered that a needlefelt produced by a needlefelting machine having a needleboard which is curved or otherwise shaped to ensure fibre entanglement in a range of angles (transverse to the plane of the felt web) exhibits surprisingly good characteristics of both wear and covering capabilities, and is particularly suitable for tennis ball coverings.

Such needlefelting machines are available from the Austrian Company Textiles Maschinenfabrik Dr E. Ferher AG and are known in the Trade as machines incorporating “Ferhrer H1 Technology” (see published British Patent Applications GB2306519-A, GB2310221-A, GB2312220-A, GB2315281-A, & GB2316957-A). However, these novel needle felting machines and techniques have never previously been proposed for production of a non-woven fabric having characteristics suitable to be used as a tennis ball covering.

According to a first aspect of the present invention there is provided a method of forming a felt covering for a ball, characterised by the steps of forming a needlefelt comprising an entanglement of fibres produced by needling a fibre batt in a range of angles including a plurality of angles which are non-perpendicular to the plane of the batt, and cutting or otherwise shaping the needlefelt to form a blank adapted at least partially to cover a ball.

The batt is preferably curved during needling, and where the batt is moved longitudinally as a step in the needling process, the batt is preferably curved in a longitudinal direction while being needled.

According to second aspect of the present invention there is provided a needlefelt for a ball covering, said needlefelt being characterised in that it comprises an entanglement of fibres formed by the needlefelting of a fibre batt passed through a needlefelting machine having at least one needleboard providing barbed needles to penetrate said web in a range of angles including a plurality of angles which are non-perpendicular with respect to the plane of the batt, and in that said needlefelt is cut or otherwise shaped to form a blank adapted at least partially to cover a ball.

During needling of the batt in the needlefelting machine the batt is preferably curved in the direction of its travel through the needlefelting machine, and the needleboard is preferably correspondingly curved. The needlefelting machine preferably comprises two needleboards at respective locations which are mutually displaced along the direction of travel of the batt through the needlefelting machine and which are preferably disposed to needle the batt from mutually opposite sides of the batt. Where the needlefelt incorporates a scrim, the first of said two needleboards is preferably disposed to needle the layered combination of batt and scrim from the side opposite to the scrim.

Prior to needled, the batt may be subjected to a preliminary consolidation and fibre entanglement in a pre-needling machine, the batt preferably being curved in its direction of travel through the pre-needling machine.

The ball is preferably a resilient hollow ball, and may be a tennis ball.

According to a third aspect of the present invention there is provided a felt-covered ball, characterised in that the ball-covering felt is a needlefelt comprising an entanglement of fibres formed by the needlefelting of a fibre batt passed through a needlefelting machine having at least one needleboard providing barbed needles to penetrate said web in a range of angles including a plurality of angles which are non-perpendicular with respect to the plane of the batt.

Said felt-covered ball preferably comprises a hollow resilient core to which the needlefelt covering is adhered, and said ball may be a tennis ball.

According to a fourth aspect of the present invention there is provided a felt-covered ball, characterised in that the ball is covered with needlefelt produced by the method according to the first aspect of the present invention.

According to fifth aspect of the present invention there is provided a felt-covered ball, characterised in that the ball is covered with needlefelt according to the second aspect of the present invention.

The ball according to the fourth or fifth aspects of the present invention may be a tennis ball.

Embodiments of the invention will now be described by way of example with reference to the accompanying drawings wherein

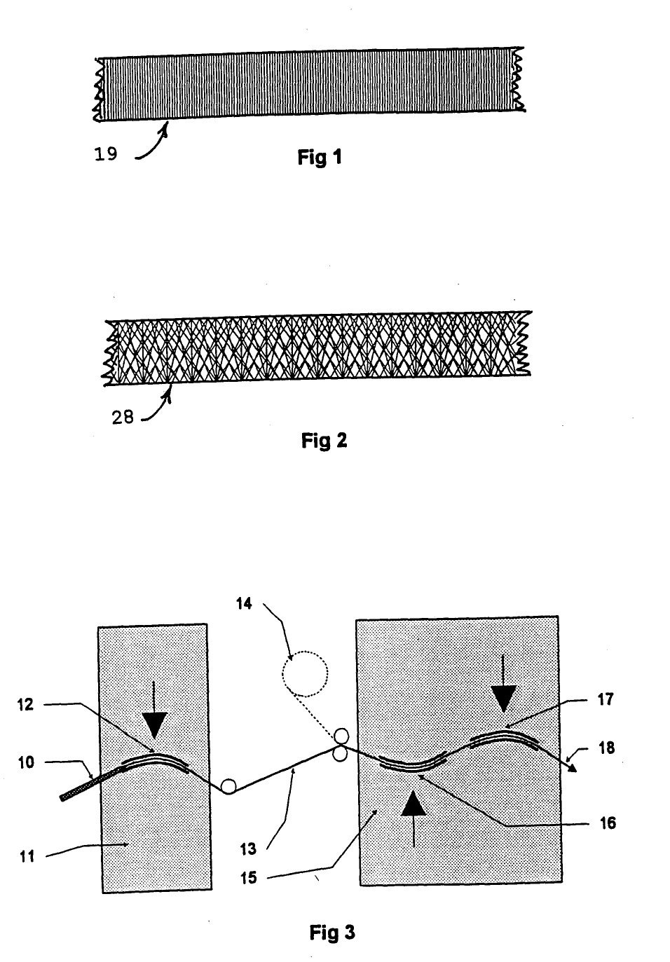

FIG. 1 is a schematic representation of the needle paths followed by the needles in conventional needling in a conventional needlefelt;

FIG. 2 is a schematic representation of the needle paths following by the needle in the needlefelt applied to ball covering in accordance with the present invention; and

FIG. 3 is a schematic representation of a needlefelting machine and process for the production of a ball-covering needlefelt in accordance with the present invention.

FIG. 4 is a schematic representation of fibre entanglement in a conventional needlefelt.

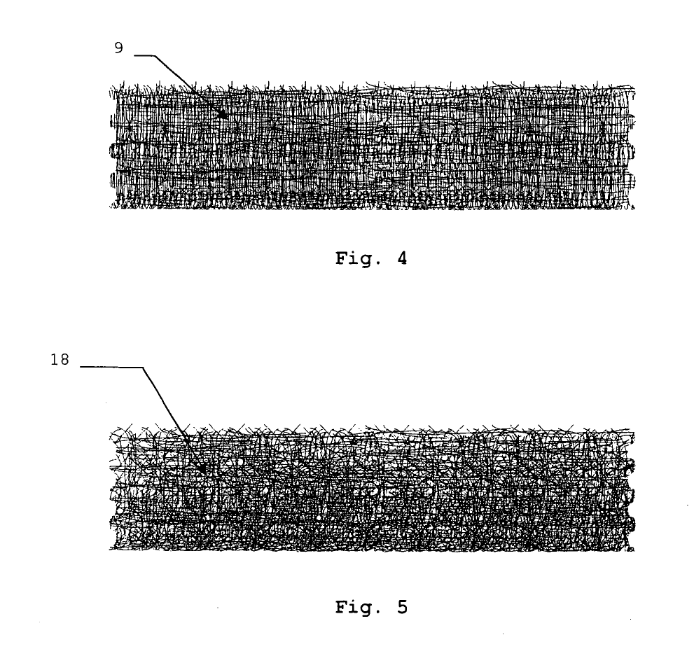

FIG. 5 is a schematic representation of fibre entanglement in the needlefelt applied to ball covering in accordance with the present invention.

Referring first to FIG. 4, this is a schematic cross-section through a conventional needlefelt 9, the cross-section being taken in a vertical longitudinal plane. The needlefelt 9 is formed from a web or batt of non-woven fibres, the batt being of indefinite length from left to right as viewed in FIG. 4 (which depicts a short piece of the batt). The vertical lines shown in FIG. 1 (19) depict the needle paths followed by the needles during the conventional needlefelting process which provoke change of orientation of some of the fibres from initially horizontal alignments to vertical alignment (i.e. at right angles to the plane of the batt). It is to be particularly noted that the fibres in this conventional needlefelt 9 are entangled to a minimal extent.

Referring now to FIG. 2, this schematically depicts the needlepaths 28 of needles used to produce a needlefelt 18 as shown in FIG. 4 with highly entangled fibres. Such needlepaths are produced by the needlefelting machinery about to be described with reference to FIG. 3. To produce the needlefelt 18 of FIG. 5, an appropriate blend of fibres, either dyed or undyed, is carded and cross-lapped to form a fibre batt 10 (FIG. 3) as a starting material for the needlefelting processes to follow. The batt 10 weighs between 350 grams per square metre and 850 grams per square metre depending on the weight required for the finished product. The fibres of the batt 10 could be composed of a mixture of wool and polyamide fibres, but other fibres could be incorporated or substituted as necessary or desirable.

The batt 10 is then passed through a pre-needling needlefelting machine 11 wherein the batt is curved while being needled such that the needles penetrate the batt in a range of angles, including a plurality of angles which are non-perpendicular to the surface of the batt. The machine 11 has a correspondingly curved needleboard 12 containing about 5000 needles disposed in a down-punch configuration (i.e. the needles are driven into the batt from above). The pre-needling machine 11 is advantageously of the type described in GB2315281-A, and as sold under the Trade Name “Fehrer H1 Technology” by the Fehrer Company of Austria.

The shape and size of the needles selected for use in the pre-needling machine 11 would depend on the results required. These needles are preferably three-inch, 40-gauge needles with regular barbs. Draft (reduction of linear density by drawing or longitudinal stretching), needle penetration depth and penetration density (number of needle penetrations per unit area of batt) are varied according to product requirements. For a tennis ball covering of good quality it is preferred to use a draft of about 15% and to provide a penetration depth of about 10 millimetres at about 80 needle penetrations per square centimetre of batt.

The pre-needled batt of fibres 13 as delivered from the pre-needling machine 11, together with an appropriate scrim (backing fabric) 14, are passed through a finish needling machine 15 with the width and length of the batt 13 being generally horizontal. The scrim 14 is preferably a polyester or polyamide warp knit with a weight of about 75 grammes per square metre. The machine 15 has two needleboards 16 & 17, each needleboard of the needleboards 16 & 17 containing approximately 5000 needles, the first needleboard 16 being disposed in up-punch configuration and the second needleboard 17 being disposed in down-punch configuration. (“Up-punch” refers to the needles being driven into the batt from below, and “down-punch” refers to the needles being driven into the batt from above). Each of the needleboards 16 & 17 is curved in a longitudinal plane, i.e. a plane which extends in the direction of batt travel through the needling machine 15 and which is also vertical to the lateral extent of the generally horizontal batt 13 (e.g. as described in GB2306519-A & GB2312220-A), the batt 13 (and scrim 14) being correspondingly curved during needling by the respective needleboards 16 & 17. Such curvature results in the batt 13 and scrim 14 being needled in a range of angles, including a plurality of angles which are non-vertical to the surface of the batt, thereby to produce a needlefelt in which the fibres are highly entangled (as depicted in FIG. 2).

At the upstream or input end of the needling machine 15, the scrim 14 is in-fed to lie along and above the fibre batt 13. Thus the first (up-punch) needleboard 16 of the finish needling machine 15 will needle fibres from the fibre batt 13 upwardly through the scrim 14 while the second (down-punch) needleboard 17 will needle fibres back down through the scrim 14 into the fibre batt 13. By selectively altering the punch density and the depth of needle penetration by the second needleboard 17 it is possible to controllably alter the fibre density through the thickness of the finished needlefelt 18.

The needles selected for use in the finish needling machine 15 would depend on the results required. These needles are preferably 3-inch, 40-gauge needles with regular barbs. Draft, needle penetration depth and penetration density can be varied according to product requirements; by suitably varying these parameters it is possible to alter the flexing characteristics, surface appearance and wear characteristics of the product. For tennis ball coverings of a good quality it has been found that a penetration of 14 millimetres at down-punch and a penetration of 10 millimetres at up-punch with a punch density of 80 penetrations per square centimetre without drafting (i.e. without reducing linear density by drawing or longitudinal stretching) can produce good results with regard to meeting the performance characteristics required for championship tennis. Reference to FIG. 2 will show the reason for this improvement in properties, namely the entanglement of fibres at various different angles due to the several different needle penetration angles arising from the imposition of longitudinal curvature on the batt as it is needled (see FIG. 6 of GB2310221-A, & FIG. 1 of GB2312220-A).

The needlefelt tennis ball covering material so produced may optionally be subjected to further processing. For example, a woollen milling process can, if required, be used to enhance the felt characteristics, particularly in respect of appearance and some aspects of wear. Additionally, the needlefelt may be dyed at this stage and dried. A shearing or cropping process may also be deemed appropriate.

The needling process carried out on longitudinally curved batt produces fibre entanglement by moving fibres through the thickness of the felt at angles other than the conventional 90 degrees to the felt surface thus giving increased fibre to fibre contact at lower punching densities. This allows the manufacture of a needlefelt having high levels of fibre entanglement but without excessive consolidation. By using such needlefelting technology and controlling the depth of needle penetration it is possible to vary and control the density of the felt through its thickness.

To make a tennis ball covered by the needlefelt obtained by the process described with reference to FIG. 3, suitably shaped blanks are cut from the needlefelt, and then glued on to a ball core constituted by a resilient hollow rubber sphere of appropriate dimensions. Such blanks may be the “figure-eight” blanks traditionally used in pairs for forming the covering of a tennis ball. The scrim 14 provides a smooth backing surface enabling good adhesion between the needlefelt and the hollow rubber core of the ball.

The preferred needling machinery for producing ball-covering felts is schematically depicted in FIG. 3, but modified arrangements may be utilised. For example, two separate needling machines (not shown) may be utilised in tandem (with suitable synchronisation of batt movement). Alternatively, a needling machine with only a single needleboard may be utilised. The pre-needling machine may be integrated with the needling machine, or omitted from the needlefelting process.

While certain modifications and variations of the preferred embodiments have been described above, the invention is not restricted thereto, and other modifications and variations can be adopted without departing from the scope of the invention as defined in the appended claims.

1. A method of forming a felt covering for a ball, characterised by the steps of forming a needlefelt comprising an entanglement of fibres produced by needling a fibre batt in a range of angles including a plurality of angles which are non-perpendicular to the surface of the batt, and cutting or otherwise shaping the needlefelt to form a blank adapted at least partially to cover a ball.

2. A method as claimed in claim 1, characterised in that the batt is curved during needling.

3. A method as claimed in claim 2 wherein the batt is moved longitudinally as a step in the needling process, characterised in that the batt is curved in a longitudinal direction while being needled.

4. A needle felt for a ball covering, said needlefelt being characterised in that it comprises an entanglement of fibres formed by the needlefelting of a fibre batt passed through a needlefelting machine having at least one needleboard providing barbed needles to penetrate said batt in a range of angles including a plurality of angles which are non-perpendicular with respect to the surface of the batt, and in that said needlefelt is cut or otherwise shaped to form a blank adapted at least partially to cover a ball.

5. A needlefelt as claimed in claim 4, characterised in that during needling of the batt in the needlefelting machine the batt is curved in the direction of its travel through the needlefelting machine.

6. A needlefelt as claimed in claim 5, characterised in that the needleboard is correspondingly curved.

7. A needlefelt as claimed in claim 4, characterised in that the needlefelting machine comprises two needleboards at respective locations which are mutually displaced along the direction of travel of the batt through the needlefelting machine.

8. A needlefelt as claimed in claim 7, characterised in that the two needleboards are respectively disposed to needle the batt from mutually opposite sides of the batt.

9. A needlefelt as claimed in claim 8 and wherein the needlefelt incorporates a scrim, characterised in that the first of said two needleboards in the direction of travel of the batt through the needlefelting machine is disposed to needle the layered combination of batt and scrim from the side opposite to the scrim.

10. A needlefelt as claimed in claim 3, characterised in that prior to being needled, the batt is subjected to a preliminary consolidation and fibre entanglement in a pre-needling machine.

11. A needlefelt as claimed in claim 10, characterised in that while being partially consolidated in the pre-needling machine, the batt is curved in its direction of travel through the pre-needling machine.

12. A needlefelt as claimed in claim 4, characterised in the ball is a resilient hollow ball.

13. A needlefelt as claimed in claim 12, characterised in that said ball is a tennis ball.

14. A felt-covered ball, characterised in that the ball-covering felt is a needlefelt comprising an entanglement of fibres formed by the needlefelting of a fibre batt passed through a needlefelting machine having at least one needleboard providing barbed needles to penetrate said web in a range of angles including a plurality of angles which are non-perpendicular with respect to the surface of the batt.

15. A felt-covered ball as claimed in claim 14, characterised in that the ball comprises a resilient hollow core to which the needlefelt is adhered.

16. A felt-covered ball as claimed in claim 15, characterised in that the ball is a tennis ball.

17. A felt-covered ball, characterised in that the ball is covered by a needlefelt produced by the method as claimed in claim 1.

18. A felt-covered ball, characterised in that the ball is covered by a needlefelt as claimed in claim 4.

19. A felt-covered ball as claimed in claim 17 or in claim 18, characterised in that the ball is a tennis ball.

20. A needlefelt as claimed in claim 4, characterised in that prior to being needled, the batt is subjected to a preliminary consolidation and fibre entanglement in a pre-needling machine.

21. A needlefelt as claimed in claim 20, characterised in that while being partially consolidated in the pre-needling machine, the batt is curved in its direction of travel through the pre-needling machine.
